(19) United States
(12) Patent Application Publication
(10) Pub. No.: US 2006/0284348 A1
(43) Pub. Date: Dec. 21, 2006

(54) Method of, and apparatus for, forming an article and an article formed thereby

(75) Inventor: Frank Matich, Bayview (AU)

Correspondence Address: CONNOLLY BOVE LODGE & HUTZ LLP, P.O. BOX 2207, WILMINGTON, DE, 19899-2207, US

(73) Assignee: Armacel PTY Ltd., Belrose (AU)

(21) Appl. No.: 10/579,901

(22) PCT Filed: Jun. 24, 2004
(86) PCT No.: PCT/AU04/00826

§ 371 Date: May 19, 2006

(30) Foreign Application Priority Data
Jun. 25, 2003 (AU) 2003903211

(51) Int. Cl. B29C 51/12

(52) U.S. Cl. 264/510; 264/544; 425/387.1

(57) ABSTRACT

The present invention discloses a method and apparatus to permit the ARMACEL process (known per se from WO 95/23682, WO/09166 and WO 00/59709) to be used without entrapping gas or air between a heated plastics sheet (26) and an impervious core (40, 50, 60, 70). The core (40, 50, 60, 70) is inclined relative to the sheet (26) by either maintaining the sheet (26) level and inclining the core (40, 50, 70) or by maintaining the core (60) level and depressing the sheet (26) to incline same. Apparatus is also disclosed including and inclined perforated base plate (22), a contact finger (55) and a pedestal (71).

### FIELD OF THE INVENTION

The present invention relates to a method of, and apparatus for, forming an article from at least one shape defining fluid impermeable interior member and at least one external skin. The present invention also relates to an article produced in accordance with the method or by the apparatus.

### BACKGROUND OF THE INVENTION

It is known to produce structurally strong articles having load bearing capabilities by encapsulating inherently weak materials, such as expanded polystyrene (EPS), with one or more layers of a thermoplastic sheet material, such as APET (amorphous polyethylene terphalate) using the ARMACEL (Trade Mark) process.

The process is described in the applicant's International Patent Application No. PCT/AU95/00100 entitled: “A Method and Apparatus for Forming Structural Articles” (WO 95/23682) and International Patent Application No. PCT/AU96/00541 entitled: “Layered Structural Article” (WO 97/09166) and International Patent Application No. PCT/AU00/00250 entitled “Improved Method of Forming Structural Articles” (WO 00/59709), the relevant disclosure of each being incorporated herein by cross-reference. These documents disclose numerous other material suitable for the core and the thermoplastics sheet.

The ARMACEL process will now briefly be described with reference to FIGS. 1 to 4. FIG. 1 shows a block shaped core 20 of essentially air or fluid permeable material, such as EPS. The core 20 is placed above a base plate 22 which primarily functions to support the core 20 and has a series of small holes 24 therethrough. Overlying the core 20 is a sheet 26 of thermoplastic material such as APET, the periphery of which is clamped by means of a clamp 28. The clamp 28 extends all the way around the periphery of the core 20 in order to provide an effective seal together with the base plate 22.

The sheet 26 is heated by means of a heater (not shown but disclosed in the abovementioned specifications) until it is at least soft or plastically deformable and is then moved relatively towards the core 20 while clamped by clamp 28. The relative movement is accomplished by either moving the clamp 28 downwardly in the direction of arrow A, or moving the base plate 22 and core 20 upwardly in the direction of arrow B, or both. The air or gas located between the sheet 26 and the base plate 22 is drawn through the core 20 and the sheet 26 is conformed to the shape of the core 20. As the core 20 is fluid permeable, the air which is located between the sheet 26 and the core 20 is able to pass through the core 20 and out the holes 24 in the base plate 22, as indicated by arrows 30.

The removal of the air or gas can be brought about by applying a reduced pressure or vacuum to the holes 24, by applying a positive pressure to the upper side of the sheet 26, or by both methods simultaneously. The pressure difference is applied for a sufficient length of time for the sheet 26 to cool, or be cooled, and thereby adopt a final position which is conformed to the shape of the core 20 and which binds the sheet 26 and the core 20 together by the creation of tensional forces in all directions in the sheet 26. After the release of the clamp 28, edges 29 of the sheet 26 can be trimmed adjacent the periphery of the core 20.

FIG. 2 shows the product of the above process after trimming and inversion. The sheet 26 effectively renders the core 20 fluid impermeable. The coated side 32 is then punctured so as to form a series of apertures 34 to render it fluid permeable again. The process of FIG. 1 is then repeated, as shown in FIG. 3, and the air between upper sheet 36 and the core 20 passes through the fluid permeable core 20 and thereafter through the apertures 34 in the lower sheet in similar fashion to that previously described.

FIG. 4 diagrammatically illustrates the situation that occurs if the above process is used in conjunction with a fluid impermeable core 38. In this case, when a sheet 37 and the core 38 are brought together the air between the two is unable to pass through the core 38 as it is fluid impermeable and is trapped to form a bubble like space 39, preventing the sheet 37 from engaging the major surface 38a of the core 38. The relative movement of the core 38 towards the sheet 37 can also create an air current which partially “balloons” the sheet 37, which exacerbates the problem. This is a particular problem when the core has a large surface area or when the movement is performed quickly. A similar situation occurs when attempting to coat the second side of a coated fluid permeable core 20, such as that shown in FIG. 2, without the apertures 34.

The invention disclosed in WO 00/59709 is an attempt to overcome the problem explained herein in relation to FIG. 4. In WO 00/59709 the article to be encapsulated is provided with relatively large grooves or channels which assist in removal of the air or gas between the impermeable body or core 38 and the sheet 37. Even so, not all of the air or gas is removed as illustrated in FIG. 4 of WO 00/59709. This can have consequence when the entrapped air or gas is heated since the heated air or gas expands and therefore exerts a force on the underlying body.

Prior art searches conducted since the priority date have disclosed PCT/AU98/00957 McCORMACK entitled “Vacuum Press for Pressing Thermoplastic Membrane onto an Article” and published under WO 99/25515. This specification seeks to overcome the abovementioned problems by evacuating the air or gas lying to both sides of the heated plastics sheet. Then, when the-heated plastics sheet is judged to be sufficiently soft, air at atmospheric pressure is introduced above the sheet to drive the heated sheet into contact with the article to be coated. The disclosure is to maintain both the object 10 to be coated level (by being supported by the flat base of the chamber 7) and to maintain sheet 11 level whilst heating (by maintaining the sheet 11 at the height of the emitter 26 and transducer 24). Thus there is no disclosure of inclining of the sheet 11 relative to the object 10.

### OBJECT OF THE INVENTION

It is an object of the present invention to substantially overcome, or at least ameliorate, some of the above difficulties with the prior art and, in particular, to provide methods of forming articles having at least one shape defining fluid impervious interior members and at least one external skin.

### SUMMARY OF THE INVENTION

Accordingly, in a first aspect, the present invention discloses a method of forming an article having load bearing capabilities from at least one shape defining fluid impermeable interior member and at least one external skin, said method comprising the steps of:—

(i) heating a thermoformable sheet intended to form the external skin,

(ii) disposing a major surface of the member(s) at an inclined angle relative to the sheet,

(iii) moving said heated sheet relative to said member(s) to bring the heated sheet into substantially point or line contact with the surface of the member(s),

(iv) applying a fluid pressure differential between the side of said sheet remote from the member(s) and the side of the member(s) remote from said sheet and continuing the relative movement between the sheet and the member(s), to progressively move the point or line contact front between the sheet and the member(s) across the surface thereby expelling any gas present between the sheet and the surface of the major surface and conforming the sheet to the shape of the major surface and mutually engaging the sheet and the member(s),and

(v) maintaining said fluid pressure differential until said thermoformable sheet has cooled, whereupon tensional forces arise in the sheet in all directions

In an embodiment, the major surface(s) of the member(s) is/are disposed at approximately 90° to the sheet and the contact front moves in a substantially vertical direction along the surface(s). In a variation of this embodiment, when the member(s) has/have a pair of parallel or upwardly converging surfaces, the sheet is applied to both the surfaces simultaneously.

In another embodiment, the surface is inclined at an angle less than 40°, most preferably about 20°.

In a further embodiment, a contact finger is used to deform the heated sheet into a V or cone shape having an apex contacting the major surface(s) of the member(s) thereby dividing the sheet into two regions each disposed at the inclined angle to the surface of the interior member(s), whereby subsequent relative movement between the sheet and the surface progressively moves a contact front for each region of the sheet across the major surface(s).

In a second aspect, the present invention discloses an apparatus for forming an article having load bearing capabilities from at least one shape defining fluid impermeable interior member and at least one external skin, said apparatus comprising:—
a sheet holding device to hold a sheet of thermoformable plastics material at least a pair of opposite edges thereof;
inclining means to dispose a major surface of said member(s) at an inclined angle relative to said sheet;
translation means to move the member relative to the sheet holding device to move the sheet and the surface together;
heating means to heat a thermoformable plastic sheet held in said sheet holding device to at last partially soften said sheet;
pressure differential means to create a pressure differential between the sheet and the member(s) to conform the sheet to the member(s), wherein the translation means move the heated sheet into substantially point or line contact the with said major surface of the member(s) and thereafter progressively moves the point or line contact front between the sheet and the member(s) across the major surface thereby expelling any gas present between the sheet and the major surface; and
maintaining said pressure differential until said thermoformable sheet has cooled, whereupon tensional forces arise in the sheet in all directions.

In a third aspect, the present invention discloses an article coated by the above method and/or apparatus.

### BRIEF DESCRIPTION OF THE DRAWINGS

Preferred embodiments of the invention will now be described, by way of example only, with reference to the accompanying drawings in which;

FIG. 1 is a cross-sectional view of a prior art method of forming an article from a fluid permeable member and an external skin;

FIG. 2 is an inverted cross-sectional side view of the article formed in FIG. 1;

FIG. 3 is an article shown in FIG. 2 being coated with a further external skin in accordance with the prior art method of FIG. 1;

FIG. 4 is a cross-sectional side view of a prior art method of forming an article from a fluid impervious member and an external skin;

FIG. 5 is a cross-sectional side view of the initial stages of a method of forming an article from a fluid impervious member and an external skin in accordance with a first embodiment of the invention;

FIG. 6 is a cross-sectional side view of a subsequent stage of the method shown in FIG. 5;

FIG. 7 is a cross-sectional inverted side view of the article formed in FIGS. 5 and 6 being coated with a further external coating in accordance with the method of FIGS. 5 and 6;

FIG. 8 is a cross-sectional side view of the initial stages of a method of forming an article from a fluid impervious member and an external skin in accordance with a second embodiment of the invention;

FIG. 9 is a cross-sectional side view of the article shown in FIG. 8 during the coating process;

FIG. 10 is a cross-sectional side view of the article shown in FIG. 8 after the coating process;

FIG. 11 is a cross-sectional side view of the initial stages of a method of forming an article from a fluid member and an external skin in accordance with a third embodiment of the invention;

FIG. 12 is a cross-sectional side view of the initial stage of a method of forming an article from a fluid impermeable member and an external skin in accordance with a fourth embodiment of the invention.

FIG. 13 is a view similar to FIG. 7 but showing the member mounted on a pedestal, and

FIG. 14 is a perspective view of a core member containing a plurality of shallow incisions.

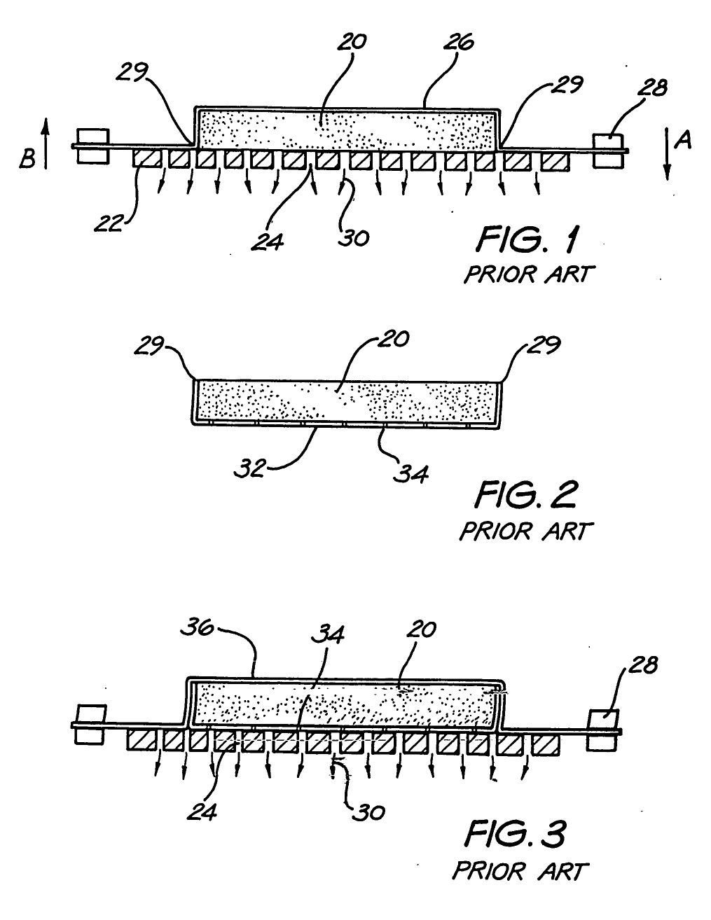

### DETAILED DESCRIPTION

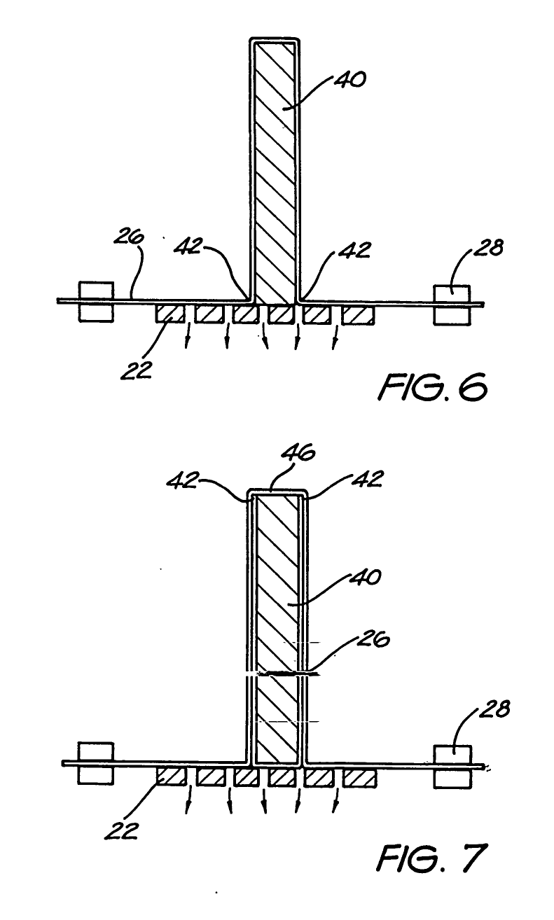

Referring to FIGS. 5 to 7, there is shown a method of forming an article having load bearing capabilities according to a first embodiment of the invention. FIG. 5 shows a core 40 of essentially fluid impermeable material, such as metal, glass or dense wood.

The core 40 is placed above a base plate 22 which primarily functions to support the core 40 and has a series of small holes 24 therethrough. Overlying the core 40 is a first sheet 26 of APET, the periphery of which is clamped by means of a peripheral clamp 28.

The sheet 26 is heated by means of a heater (not shown but disclosed in the abovementioned specifications) until it is at least soft or plastically deformable and is then moved relative to the core 40 whilst clamped by the clamp 28. The relative movement is accomplished by moving the clamp 28 downwardly in the direction of arrow C (as shown in FIG. 5) or moving the base plate 22 and core 40 upwardly in the direction of arrow D, or both.

As the sheet 26 and base plate 22 are drawn towards each other a pressure differential is created between the sheet 26, core 40 and base 22 drawing air or gas located from between sheet 26 and core 40 as to form the sheet 26 to the shape of the core 40.

As best shown in FIG. 5, the side surfaces 41 of the core 40 are disposed at an angle of approximately 90 degrees to the sheet 26 and two line contact fronts, each indicated as X, are formed between the (major) side surfaces 41 of the core 40 and the sheet 26. As the sheet clamp 28 is moved relative to the core 40, the fronts XX move in a substantially vertical direction along the side surfaces 41 of the core 40. The progressive movement of the contact fronts across the side surfaces 41 simultaneously expels any air present between the sheet 26 and the side surfaces 41 of the core 40 and then allows the sheet 26 to conform to the shape of the core 40. This air removal process advantageously obviates the need for the interior member to be fluid permeable, as air or gas is not required to pass through same.

After the side surfaces 41 of the core 40 have been fully covered by the sheet 26, the pressure differential is maintained for a sufficient length of time for the sheet 26 to cool, or be cooled, and thereby adopt a final position which is conformed to the shape of the core 40. This binds the sheet 26 and the core 40 together and creates tensional forces in all directions of the sheet 26.

After the release of the clamp 28, edges 42 of the sheet 26 are trimmed at the periphery of the core 40. In this embodiment it will be appreciated that the peripheral clamp 28 extends all the way around the periphery of the core 40 in order to provide an effective seal together with the base plate 22.

FIG. 7 shows the product of the above process after trimming and inversion. The process is then repeated, as shown in FIG. 7, and the air or gas between second sheet 46 and the core 40 is evacuated in a similar fashion to that previously described.

The process as shown in FIG. 7 can also be used with a permeable core, that has been rendered impermeable by coating, without requiring the apertures 34 described with reference to FIG. 3. Ass a consequence, a second coat of sheet thermoplastic material can be applied to a core which has previously been fully encapsulated with a prior coat of sheet thermoplastic material.

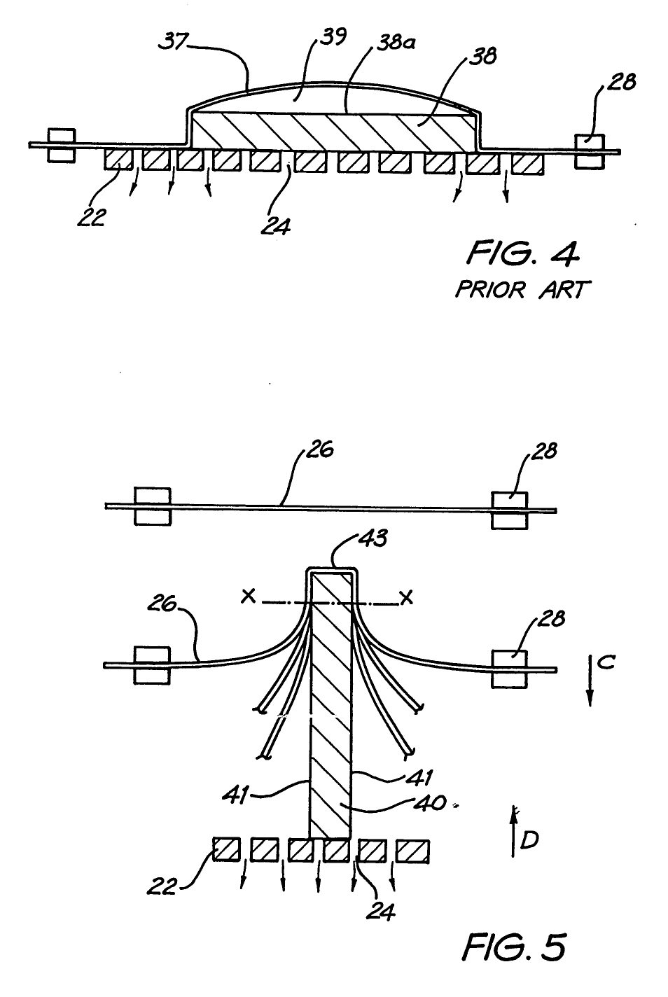

The bubble 39 shown in FIG. 4 is not formed against the (minor) top surface 43 as the sheet 26 effectively makes instantaneous contact with all of the top surface 43. Preferably the top surface 43 can be tilted slightly so that one edge thereof contacts the sheet 26 before the opposite edge. Further, the small surface area of the top surface 43 does not create the air current described above with reference to FIG. 4.

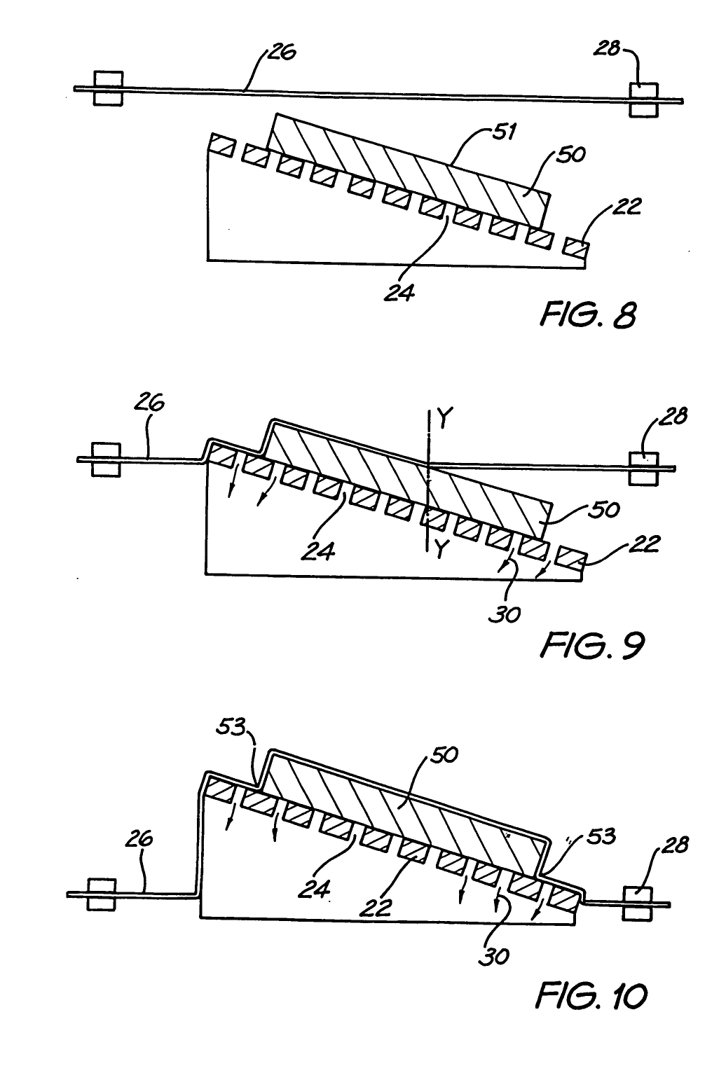

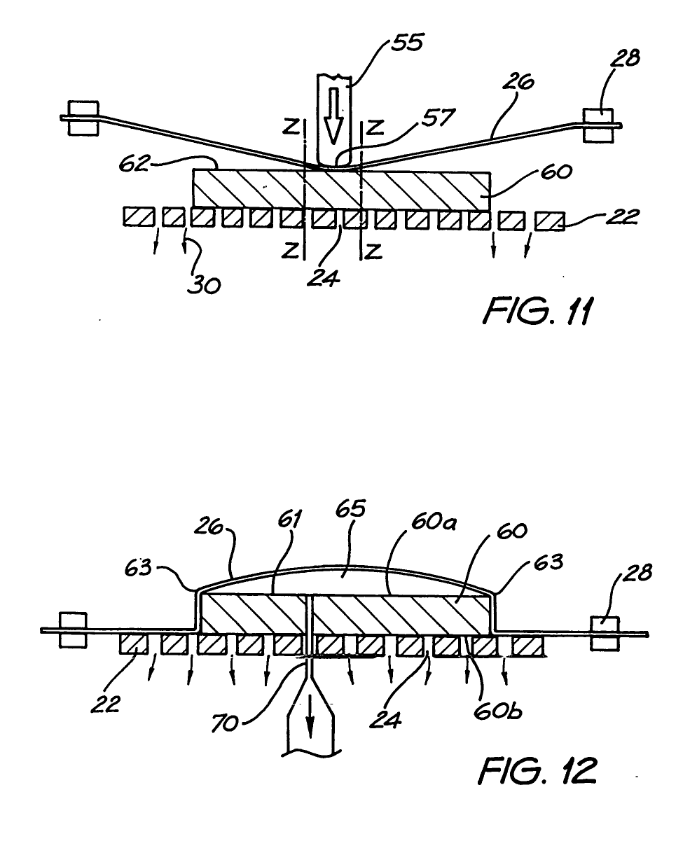

FIGS. 8 to 10 show a similar process to that shown in FIGS. 5 to 7 except a major surface 51 of a fluid impervious core 50 is inclined at an angle less than 40 degrees to the sheet 26. As the sheet 26 and base plate 22 are moved toward each other a line contact front, in this case indicated by YY, between the sheet 26 and the core 50 progressively moves down the surface 51 of the core 50. This progressively expels the air or gas between the sheet 26 and the surface 51 and allows the sheet 26 to conform to the core 50. After release of the clamp 28, the edges 53 of the sheet are trimmed at the periphery of the core 50. The product can then be inverted and the process repeated as previously described.

FIG. 11 shows a similar process to that shown in FIGS. 8 to 10 except that the inclination of the sheet relative to the core is created by a contact finger 55 which is used to deform the heated sheet 26 into a V or cone-shape having an apex 57 contacting a major surface 62 of a fluid impervious core 60. This divides the sheet 26 into two regions each disposed at an inclined angle to the major surface 62 of the core 60, each having a line contact front indicated by ZZ. The core 60, as in all of the other embodiments, is placed above a base plate 22 which primarily functions to support the core 60 and has a series of small holes 24 therethrough. Upon the application of a fluid pressure differential between the sheet 26 and the core 60 and relative movement between the sheet 26 and the surface 62, the contact fronts ZZ for each respective region of the sheet 26 progressively move across the surface 62. This expels any air or gas present between the sheet 26 and the surface 62 of the core 60 and allows the sheet 26 to conform to the shape of the core 60. The edges of the sheet (not shown) are then trimmed so as to have the same periphery as the core. Then the core is inverted and the process repeated.

FIG. 12 shows a method of forming an article having load bearing capabilities according to a further embodiment of the invention. As was described with reference to prior art FIG. 4, as the sheet 26 and base plate 22 are moved towards each other, and the pressure differential is applied, the air or gas between the sheet 26 and top surface 61 is trapped between the edges of the core 60, because it is fluid impermeable, thereby creating a bubble-like space 65. To expel this air or gas and allow sheet 26 to conform to core 60, one or more tubes 70 are inserted through one of the holes 24 in base plate 22. Each tube lies alongside the core 60 allowing fluid communication between the major surfaces 60a and 60b of the core 60. A vacuum is then applied to the tube(s) 70 to remove the air or gas present in the space 65 between the sheet 26 and the core 60 which allows the sheet 26 to conform to the core 60. As with earlier embodiments, the pressure differential is maintained until the sheet 26 has cooled, thereby creating tensional forces in the sheet 26 in all directions. In the trimming process, the tube(s) 70 which are encapsulated below the sheet 26 can be removed by trimming the sheet 26 at the upper edges 63 of the core 60. Then the core 60 can be inverted and the process of FIGS. 8-10 used to coat the remaining surfaces of the core 60. This technique finds particular application in coating a body having one surface which is difficult to coat but having its remaining surfaces easy to coat.

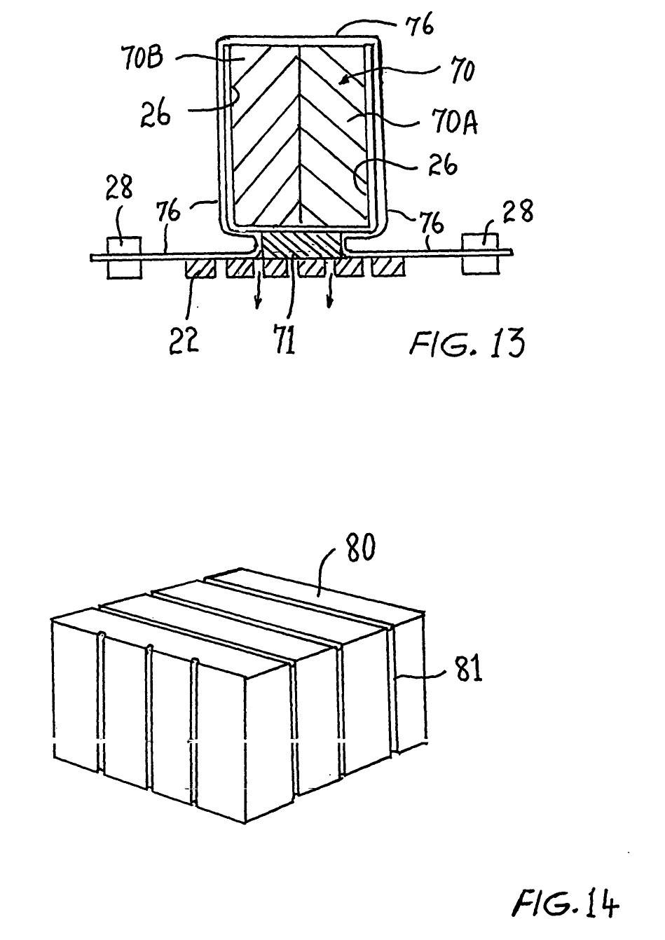

Turning now to FIG. 13, the encapsulation of a two part core 70 having individual core members 70A and 70B is illustrated. As in FIG. 7, the core 70 has previously been coated on its top and sides by a sheet 26 of thermoplastic material. The sheet 26 is trimmed and the core members 70A and 70B inverted and placed on a pedestal 71 which is in turn supported by the base plate 22.

Then a second sheet 76 is applied as in FIG. 7. However, because of the pedestal 71, the second sheet 76 is drawn around the lower edges of the core 70 as seen in FIG. 13. The sheet 76 is trimmed to allow the release of the pedestal. As the trimmed sheet 76 envelopes the lower edge of the core 70 as seen in FIG. 13, this provides an exceptionally strong bond for the sheet 76.

Turning now to FIG. 14, a still further embodiment is illustrated in which a block shaped core 80 is provided with a series of score lines or incisions 81. These are illustrated in a greatly magnified form in order to be visible at all in the drawing. The incisions 81 essentially constitute scratches in the surface of the core 80. These provide channels which allow the air or gas between core 80 and the sheet 26 to escape but are essentially invisible in the finished article. It is not necessary that the incisions 81 be as regularly spaced or as uniformly deep as is illustrated in FIG. 14.

The primary advantage of the invention is it extends the use of the ARMACEL process to relatively high strength, and fluid impervious or substantially impervious, materials such as metal, glass or dense wood.

The foregoing describes only some embodiments of the present invention and modifications, obvious to those skilled in the art can be made thereto without departing from the scope of the present invention. For example, the core can be fabricated from one, two, or multiple parts.

The term “comprising” (and its grammatical variations) as used herein is used in the inclusive sense of “having” or “including” and not in the exclusive sense of “consisting only of”.

1. A method of forming an article having load bearing capabilities from at least one shape defining fluid impermeable interior member and at least one external skin, said method comprising the steps of:—
(i) heating a thermoformable sheet intended to from the external skin,
(ii) disposing a major surface of the member(s) at an inclined angle relative to the sheet,
(iii) moving said heated sheet relative to said member(s) to bring the heated sheet into substantially point or line contact with the surface of the member(s),
(iv) applying a fluid pressure differential between the side of said sheet remote from the member(s) and the side of the member(s) remote from said sheet and continuing the relative movement between the sheet and the member(s), to progressively move the point or line contact front between the sheet and the member(s) across the surface thereby expelling any gas present between the sheet and the member(s) across the surface thereby expelling any gas present between the sheet and the surface of the major surface and conforming the sheet to the shape of the major surface and mutually engaging the sheet and the member(s), and
(v) maintaining said fluid pressure differential until said thermoformable sheet has cooled, whereupon tensional forces arise in the sheet in all directions.

2. The method as claimed in claim 1 wherein carryout step (ii) said heated sheet is maintained substantially flat and said major surface is inclined relative to said flat sheet.

3. The method as claimed in claim 1 wherein in carrying out step (ii) said heated sheet is deformed to be inclined relative to said major surface.

4. The method as claimed in claim 3 wherein said heated sheet is deformed by pressing a contact member into that side of said sheet remote from said major surface.

5. The method as claimed in claim 4 wherein said contact finger deforms said heated sheet into a substantially V-shape or cone-shape having an apex contacting the major surface of the member(s) thereby diving the sheet into two regions each disposed at the inclined angle to the major surface, whereby subsequent relative movement between the sheet and the surface progressively moves a contact front for each region of the sheet across the major surface.

6. The method as claimed in claim 2 wherein the major surface of the member(s) is/are disposed at approximately 90° to the sheet and the contact front moves in a substantially vertical direction along the surface.

7. The method as claimed in claim 6 wherein the member(s) has/have a pair of parallel or upwardly converging major surfaces, and the sheet is applied to both the major surfaces simultaneously.

8. The method as claimed in claim 2 wherein the major surface of the member is inclined at an angle less than 40°.

9. The method as claimed in claim 8 wherein said angle is about 20°.

10. The method as claimed in claim 1 including the prior step of coating a first major surface of said member by positioning a tube alongside said member which opens onto said first major surface, and subsequently coating a second major surface in accordance with the method as claimed in claim 1.

11. The method as claimed in claim 1 including the further steps of locating said interior member with a first external skin, inverting said member and coating with a second external skin.

12. The method as claimed in claim 111 wherein said second external skin is inclined relative to said member during the application thereof.

13. The method as claimed in claim 11 including the further step of placing said inverted interior member on a pedestal.

14. The method as claimed in claim 1 including the further prior step of scoring or incising said interior member.

15. An apparatus for forming an article having load bearing capabilities from at least one shape defining fluid impermeable interior member and at least one external skin, said apparatus comprising:—
a sheet holding device to hold a sheet of thermoformable plastics material at least a pair of opposite edges thereof;
inclining means to dispose a major surface of said member(s) at an inclined angle relative to said sheet;
translation means to move the member relative to the sheet holding device to move the sheet and the surface together;
heating means to heat a thermoformable plastic sheet held in said sheet holding device to at last partially soften said sheet;
pressure differential means to create a pressure differential between the sheet and the member(s) to conform the sheet to the member(s), wherein the translation means move the heated sheet into substantially point or line contact the with said major surface of the member(s) and thereafter progressively moves the point or line contact front between the sheet and the member(s) across the major surface thereby expelling any gas present between the sheet and the major surface; and maintaining said pressure differential until said thermoformable sheet has cooled, whereupon tensional forces arise in the sheet in all directions.

16. The apparatus as claimed in claim 15 wherein said sheet holding device maintains said sheet substantially level, and said including means comprises an inclined former to hold said member(s) with said major surface inclined to said level sheet.

17. The apparatus as claimed in claim 16 wherein said inclined former substantially comprises an inclined perforated plane.

18. The apparatus as claimed in claim 15 wherein said inclining means comprises deforming means to deform said heated sheet into a surface which is inclined relative to said major surface.

19. The apparatus as claimed in claim 18 wherein said deforming means comprises a contact finger.

20. The apparatus as claimed in claim 19 wherein said contact finger is V-shaped or cone-shaped.

21. The apparatus as claimed in claim 1 wherein said interior member is positioned on a pedestal.

22. An article coated by a method as claimed in claim 1.
